(19) United States
(12) Patent Application Publication
(10) Pub. No.: US 2009/0138300 A1
(43) Pub. Date: May 28, 2009

(54) OPTIMIZING MANAGED BUSINESS PROCESSES

(75) Inventors: Steven M. Kagan, Burr Ridge, IL (US); John A. Ricketts, Clarendon Hills, IL (US)

Correspondence Address: GREENBLUM & BERNSTEIN, P.L.C., 1950 ROLAND CLARKE PLACE, RESTON, VA, 20191, US

(73) Assignee: INTERNATIONAL BUSINESS MACHINES CORPORATION, Armonk, NY (US)

(21) Appl. No.: 11/946,485

(22) Filed: Nov. 28, 2007

(51) Int. Cl. G06Q 10/00

(52) U.S. Cl. 705/7

(57) ABSTRACT

The invention generally relates to systems and methods for optimizing managed business processes, and, more particularly, to systems and methods for optimizing vendor payroll services. A method for allocating outsourced business processes among a plurality of performing entities includes defining a hierarchy of goals from a subset of data input to an optimization tool embodied in a computer infrastructure, wherein the data includes constraints, and iteratively running the optimization tool based on the data and the hierarchy. The method also includes relaxing at least one of the constraints to generate a solution that satisfies the data and the hierarchy, and outputting the solution.

### FIELD OF THE INVENTION

The invention generally relates to systems and methods for optimizing managed business processes, and, more particularly, to systems and methods for optimizing managed vendor payroll services.

### BACKGROUND OF THE INVENTION

A business process typically comprises a set of tasks associated with executing an operation of a business. Such processes can be performed concurrently and continuously (e.g., making sales and collecting payments), or in sequence on a frequently recurring schedule (e.g., payroll). For example, payroll services may include, but are not limited to, tasks such as: gathering data from time and attendance systems; maintaining employer and payee data covering regular employees, temporary employees, expatriates, and retirees/pensioners; payroll processing, including gross-to-net calculations, for all applicable pay cycles, including weekly, biweekly, semimonthly, and monthly; balancing of results; generating paper checks, direct deposits, and pay advice slips; optional services (that client could do itself but may choose to have others do), such as accounting, escheatment, garnishment, imaging, tax filings, and unemployment claims; and customer service.

It is common for business processes to be outsourced. For example, a client may outsource its payroll process to a primary service provider, such that the primary service provider performs at least some of the tasks involved in the process (e.g., manages the business process). In such a situation, it is possible that the primary service provider may perform the tasks of the process, or subcontract (e.g., outsource) the tasks to another performing entity (e.g., vendor). For example, in the case of providing payroll for a multi-national client, a primary service provider may perform the tasks for some of the client's payees (e.g., in some countries) and hire a vendor to perform the tasks for others of the client's payees (e.g., in other countries). A primary service provider may use vendors in this way for any number of reasons, such as, for example: to obtain service in countries where a vendor has best-of-breed solutions; the availability of optional services such as direct deposit and debit cards; presence of the vendor in the same time zones as some payees; augmentation of the primary provider's capacity; service to niche markets too small for the primary provider to serve efficiently; and relief for clients of vendor management responsibilities.

A primary service provider that utilizes multiple vendors for multiple clients with payees in multiple countries has to decide which vendors to use for which payees in each country. Many factors may be involved in making such a decision. For example, vendor price and capability are often primary factors in such a determination. Vendors typically price their payroll services based on the scope of work, service-level agreements, and number of payees in each country, with larger volumes resulting in a lower price per payslip for a given client. Furthermore, vendors may offer the primary service provider additional discounts based on the total number of payees across all clients assigned to that vendor. Thus, vendors may pass on some economies of scale in their pricing.

In terms of vendor capability, some vendors serve some countries better than others. Also, different vendors may be able to accommodate different maximum numbers of payees. So the more clients, countries, and vendors there are, the harder it becomes to make an optimal decision for contracting services out to vendors.

Furthermore, competitive pricing and vendor capability are not the only parameters for a primary service provider to consider. The assumption that all vendors are capable of providing service that meets standards for quality and timeliness becomes tenuous as the number of payees approaches each vendor's maximum capacity. That is, a vendor's physical facilities, information technology, procedures, and staffing come under stress if the vendor grows too quickly. Since growth eventually requires massive reengineering of capabilities, not all vendors are able to grow indefinitely. Thus, the primary service provider must take vendor capacity into account.

Moreover, vendors come and go via start-ups, spin-offs, acquisitions, and mergers. And vendors tend to offer better pricing in competitive markets. Thus, the primary service provider typically wants to avoid relying on just one vendor in those countries where it would prefer not to provide payroll services itself.

Accordingly, there exists a need in the art to overcome the deficiencies and limitations described hereinabove.

### SUMMARY OF THE INVENTION

In a first aspect of the invention, there is a method for allocating outsourced business processes among a plurality of performing entities. The method comprises defining a hierarchy of goals from a subset of data input to an optimization tool embodied in a computer infrastructure, wherein the data includes constraints, and iteratively running the optimization tool based on the data and the hierarchy. The method also includes relaxing at least one of the constraints to generate a solution that satisfies the data and the hierarchy, and outputting the solution.

In another aspect of the invention, there is a method for determining an optimized solution for allocation of managed business processes. The method comprises providing a computer infrastructure that is structured and arranged to receive data associated with the managed business processes, define an optimization problem based upon the data, and execute an optimization routine to solve the optimization problem. The computer infrastructure is also structured and arranged to generate an alert when the optimization problem is over-constrained, receive at least one change of at least one aspect of the data, and generate a solution to the optimization problem that satisfies the data and the at least one change.

In another aspect of the invention, a computer program product comprises a computer usable medium having a computer readable program embodied in the medium, wherein the computer readable program when executed on a computing device causes the computing device to: iteratively solve an optimization problem while descending through levels of hierarchical goals associated with a plurality of business processes; prompt a user to relax at least one constraint of the optimization problem when the optimization problem is over-constrained; and generate a solution based upon the hierarchical goals and the relaxing.

### BRIEF DESCRIPTION OF THE DRAWINGS

The present invention is described in the detailed description which follows, in reference to the noted plurality of drawings by way of non-limiting examples of exemplary embodiments of the present invention.

FIG. 1 shows an illustrative environment for implementing the steps in accordance with the invention;

FIG. 2 shows a block diagram according to aspects of the invention;

FIGS. 3-11 depict exemplary data according to aspects of the invention; and

FIG. 12 shows a flow diagram depicting implementations of a method according to aspects of the invention.

### DETAILED DESCRIPTION OF EMBODIMENTS OF THE INVENTION

The invention generally relates to systems and methods for optimizing managed business processes, and, more particularly, to systems and methods for optimizing managed vendor payroll services. Exemplary embodiments of the invention allow a primary service provider to allocate subcontracted (e.g., outsourced) business processes to performing entities (e.g., vendors) in an optimal manner that meets a hierarchy of goals and a set of constraints. According to aspects of the invention, this is accomplished using an iterative optimization system and method in which a user can selectively relax constraints until an optimum solution that satisfies the goals and constraints is feasible. In this manner, the user is provided with a tool for determining an optimal solution for managing the business processes.

For aid in understanding, the invention is described herein with respect to payroll processes. However, the invention is not limited to payroll, and aspects of the invention can be used with any business process. Examples of other business processes that implementations of the invention can be used with include, but are not limited to: mortgage origination, accounting for toll roads, parts inventory and warehousing, etc.

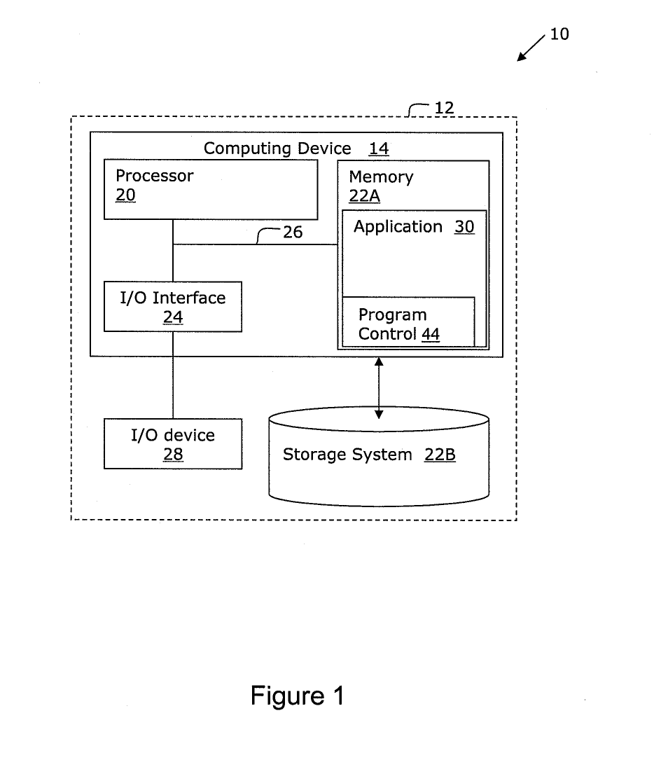

FIG. 1 shows an illustrative environment 10 for managing the processes in accordance with the invention. To this extent, the environment 10 includes a computer infrastructure 12 that can perform the processes described herein. In particular, the computer infrastructure 12 includes a computing device 14 that comprises an application 30 having a program control 44, which makes the computing device 14 operable to perform the processes described herein, such as, for example, determining an optimal solution of managed business processes. The computing device 14 includes a processor 20, a memory 22A, an input/output (I/O) interface 24, and a bus 26. The memory 22A can include local memory employed during actual execution of program code, bulk storage, and cache memories which provide temporary storage of at least some program code (e.g., program control 44) in order to reduce the number of times code must be retrieved from bulk storage during execution. Further, the computing device 14 is in communication with an external I/O device/resource 28 and a storage system 22B. The I/O device 28 can comprise any device that enables an individual to interact with the computing device 14 or any device that enables the computing device 14 to communicate with one or more other computing devices using any type of communications link. The external I/O device/resource 28 may be keyboards, displays, pointing devices, etc.

The processor 20 executes computer program code (e.g., program control 44), which is stored in memory 22A and/or storage system 22B. While executing computer program code, the processor 20 can read and/or write data to/from memory 22A, storage system 22B, and/or I/O interface 24. The bus 26 provides a communications link between each of the components in the computing device 14.

The computing device 14 can comprise any general purpose computing article of manufacture capable of executing computer program code installed thereon (e.g., a personal computer, server, wireless notebook, smart phone, personal digital assistant, etc.). However, it is understood that the computing device 14 is only representative of various possible equivalent computing devices that may perform the processes described herein. To this extent, in embodiments, the functionality provided by the computing device 14 can be implemented by a computing article of manufacture that includes any combination of general and/or specific purpose hardware and/or computer program code. In each embodiment, the program code and hardware can be created using standard programming and engineering techniques, respectively.

Similarly, the computer infrastructure 12 is only illustrative of various types of computer infrastructures for implementing the invention. For example, in embodiments, the computer infrastructure 12 comprises two or more computing devices (e.g., a server cluster) that communicate over any type of communications link, such as a network, a shared memory, or the like, to perform the processes described herein. Further, while performing the processes described herein, one or more computing devices in the computer infrastructure 12 can communicate with one or more other computing devices external to computer infrastructure 12 using any type of communications link. The communications link can comprise any combination of wired and/or wireless links; any combination of one or more types of networks (e.g., the Internet, a wide area network, a local area network, a virtual private network, etc.); and/or utilize any combination of transmission techniques and protocols.

In embodiments, the invention provides a business method that performs the steps of the invention on a subscription, advertising, and/or fee basis. That is, a primary service provider, such as a Solution Integrator, could offer to perform the processes described herein, such as, for example, determining an optimal solution of managed business processes. In this case, the primary service provider can create, maintain, deploy, support, etc., a computer infrastructure that performs the process steps of the invention for one or more customers. In return, the primary service provider can receive payment from the customer(s) under a subscription and/or fee agreement and/or the primary service provider can receive payment from the sale of advertising content to one or more third parties.

Implementations of the invention utilize an optimization tool (e.g., optimizer) to mathematically determine an optimal solution of a multi-constrained problem. In embodiments, the optimization tool is embodied in a computing device, such as that described above with respect to FIG. 1. For example, the optimizer may be part of a software application, such as application 30 described with respect to FIG. 1.

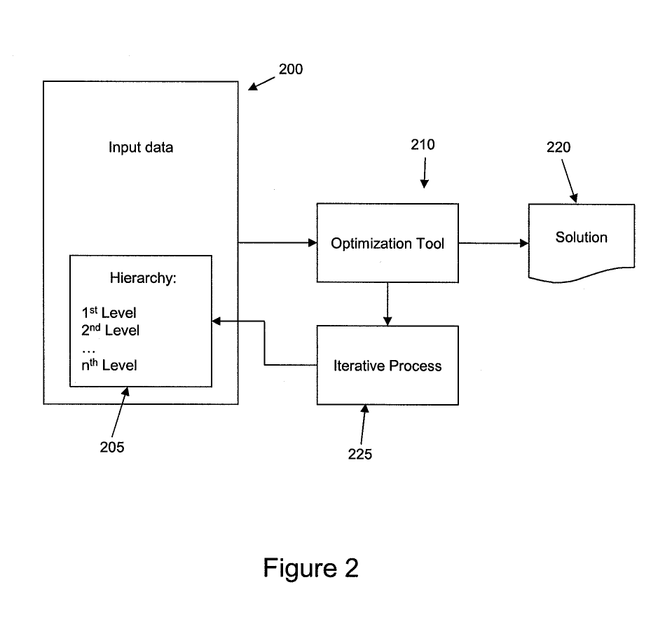

FIG. 2 shows a block diagram that represents systems and methods according to aspects of the invention. For example, input data 200 is provided to an optimization tool 210. The input data 200 is described in greater detail below, and defines a problem (such as, for example, allocating business processes to vendors while minimizing price). More specifically, in embodiments, the input data 200 includes a user-defined hierarchy of goals 205 and a set of constraints. The optimizer 210 utilizes numerical optimization techniques to generate a solution 220 that satisfies the input data 210. For example, in embodiments, the optimizer utilizes an iterative process 225 that defines and attempts to solve an optimization problem based upon the input data while descending through the levels of the hierarchy, allowing a user to relax constraints or change the hierarchy of goals until a solution is found.

In the exemplary case of a primary service provider that manages payroll services for plural clients where the payroll services are outsourced to plural vendors for payees in plural countries, an optimization tool according to aspects of the invention is configured and arranged to determine a solution that minimizes the total cost (to the primary service provider) to outsource all of the payroll processes. In embodiments, the optimization tool utilizes mathematical algorithms (e.g., linear least squares optimization, etc.) to determine a solution based upon input data including, but not limited to: baseline data, constraints, and goals.

For example, in implementations, the baseline data may include values such as: a number of payees that each client has in each country; a price that each vendor charges per payslip in each country (e.g., a rate card); a discount rate that each vendor provides based upon exceeding a number of payees, to name but a few.

Moreover, in implementations, constraints may include data such as, for example: the maximum number of payees that each vendor can handle in each country; the minimum number of payees that a vendor is willing to handle in each country; the maximum number of new payees that a vendor can add in a time period (e.g., each year); assigning all payees to a vendor; not assigning a negative number of payees to any vendor; assigning certain payees to a vendor based upon an existing contract, etc.

Additionally, in implementations, goals may include values (e.g., logical and/or numerical) relating to, but not limited to: assigning one vendor per client in each country; assigning the same vendor per client for all countries within a geographic region (set of countries with the same or similar attributes); retention of third party payroll services if price is competitive with vendors or a termination clause makes change prohibitive; utilizing more than one vendor within each country; minimizing the primary service provider's cost based on vendor rate cards for individual clients; and minimizing the primary service provider's cost based on vendor discount rates for multiple clients.

In embodiments, the input data (e.g., baseline data, constraints, and goals) are input to the optimizer in any suitable fashion, such as, for example, by a human user utilizing a graphical user interface (GUI). Additionally or alternatively, automated methods may be used to import and/or export relevant data to/from the optimizer. In this manner, the input data may be used to define a mathematical problem (e.g., optimization problem) that the optimizer can attempt to solve using known techniques (e.g., linear least squares, etc.). Numerical optimization techniques per se are known, such that further explanation is not believed necessary.

However, not all optimization problems have a determinable solution. For example, a problem that is over-constrained typically cannot be solved. Accordingly, in systems and methods according to aspects of the invention, the optimizer is structured and arranged to alert a user when the optimization problem cannot be solved based upon the given input data. Upon receiving such an alert, the user may selectively change (e.g., relax) at least one value of the input data and re-run the optimizer based upon the new (e.g., updated) input data. In embodiments, this process is repeated in an iterative fashion until a solution is reached that meets all of the input data (e.g., baseline data, constraints, and goals).

For example, in embodiments, at least some of the goals are organized in a hierarchy. The remainder of the input data (e.g., baseline data, goals and constraints) that is not included in the hierarchy is referred to herein as constant data. The optimizer is initially run using the constant data and the first level of the hierarchy. If a solution is found, then the optimizer is subsequently run using the constant data and the first and second levels of the hierarchy. The optimizer continues in this manner, descending through the levels of the hierarchy, so long as the problem is not over-constrained. If at any level of the hierarchy a solution cannot be determined (e.g., the problem is over-constrained), the optimizer generates an output that alerts the user to the conflict and at which level of the hierarchy the conflict occurred. The user then selectively relaxes (e.g., changes the value of) at least one constraint and/or goal, and re-runs the optimizer with the updated data. This process is repeated until a solution is found that satisfies the constant data and the hierarchy data.

In embodiments, the hierarchy may be defined by a user utilizing the same (or a different) GUI as that described above with respect to inputting the input data. Moreover, the relaxing (e.g., changing of values) of constraints (or goals) may be performed by a user utilizing the same (or a different) GUI. Additionally, during the iterative process, an alert that a problem cannot be solved may be output via the same (or a different) GUI.

### Example

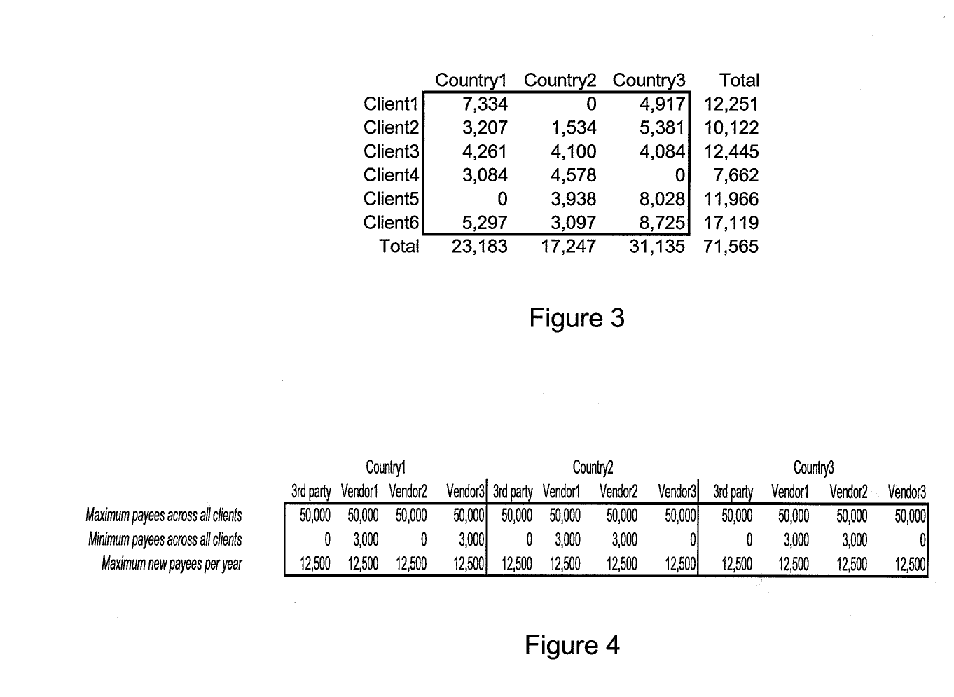

FIGS. 3-11 depict an exemplary implementation of aspects of the invention. The invention is not limited to the data types and values shown in these figures, but, rather, any suitable data types and values may be used with the invention. FIG. 3 is a table showing over seventy thousand payees across six clients in three countries. For example, a primary service provider may have a contract with these six clients to perform payroll services for the payees in the countries shown. These values represent baseline data that is input to the optimizer.

FIG. 4 illustrates exemplary vendor constraints. For example, the 3^{rd} party, Vendor1, Vendor2, and Vendor3 may represent performing entities that the primary service provider may outsource the payroll processes of the clients to. In the example shown, maximum payees is the highest number of payees each vendor can handle in each country. In embodiments, this is a firm constraint in the sense that the number of payees assigned typically will not exceed these values. Minimum payees is the lowest number of constraints each vendor is willing to handle in each country. In embodiments, this is a soft constraint in the sense that the number of payees allowed may sometimes be less than this minimum at some points in time (unless the minimum is zero). Maximum new payees per year is the rate at which each vendor can increase capacity in each country per year. These values represent input data that is provided to the optimizer.

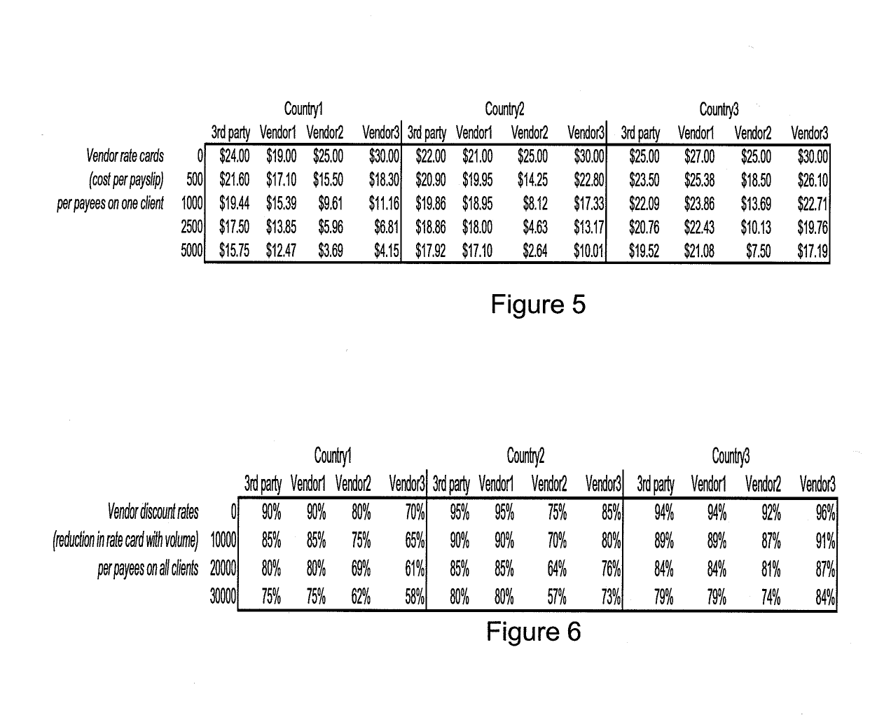

FIG. 5 illustrates exemplary vendor rate card data. For example, each column represents one vendor's rate card in a given country. More specifically, the rates are the price the vendors (from FIG. 4) charge for payroll service to an individual client (e.g., the price per payslip in a country). The first row shows the vendor's price per payslip for 0 to 499 payees, the second row is price for 500 to 999 payees, and so forth. Though not shown, separate rate cards may be provided for different types of payee (e.g., regular employees, retirees and temporary employees, and expatriates, etc.). These values represent input data provided to the optimizer.

It is conceivable in implementations that each vendor's rate card may be affected by both the vendor's fixed and variable costs. As such, it is not uncommon to see differing pricing trends amongst different rate cards (e.g., some vendors' rate cards start high and then drop below other vendors' prices). Thus, at small volumes, some vendors may have the best rates, but at higher volumes, other vendors may have the best rates. The vendors' prices expressed in their rates cards become the primary service provider's cost. In order to calculate its own price to the client, the primary service provider will cover additional costs, such as vendor management, risk management, etc.

FIG. 6 illustrates exemplary vendor discount rate data associated with the vendors listed in FIGS. 4 and 5. For example, each column represents one vendor's discount in a given country. Particularly, those discounts are the price reductions they are willing to offer for larger volumes of payees across multiple clients. The first row shows the discount for 0 to 9,999 payees, the second row is discount for 10,000 to 19,999 payees, and so forth. In embodiments, since these discounts are independent of the values of the rate card (e.g., FIG. 5), both the discount and rate card values may be used as input data for the optimizer.

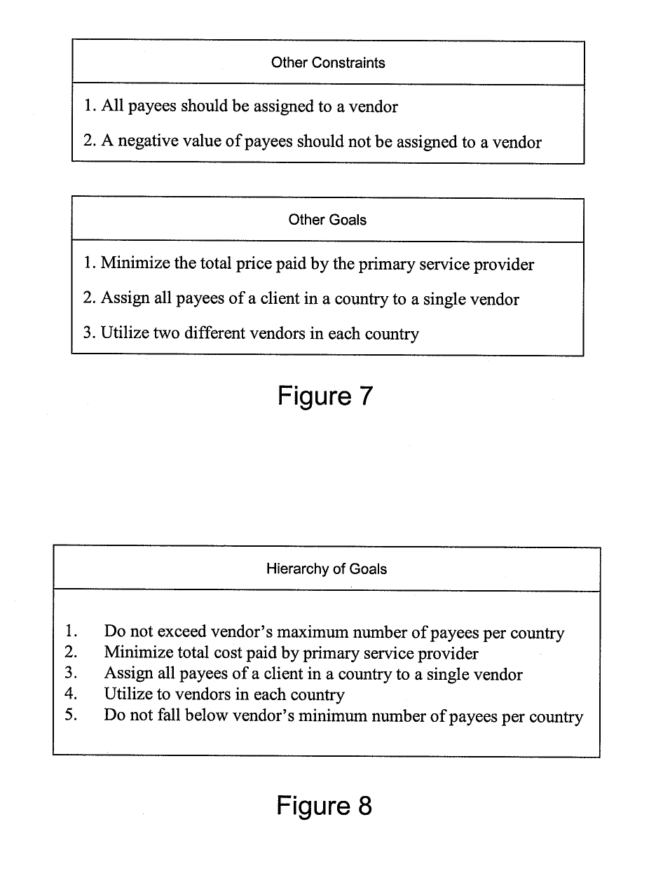

FIG. 7 shows other exemplary goals and constraints that are provided as input data to the optimizer. Such additional goals and/or constraints may be defined by the user for any suitable reason, such as a business strategy of the primary service provider. For example, a first constraint is that all payees should be assigned to a vendor. A second constraint is that a negative value of payees should not be assigned to a vendor. Similarly, a first goal is to minimize the overall price paid by the primary service provider to all of the vendors. A second goal is to assign all payees for a given client within a given country to only one vendor. A third goal is to assign payees in each country to at least two vendors. These goals and constraints are provided as input data to the optimizer (e.g., via values and/or logical expressions).

FIG. 8 shows an exemplary definition of a hierarchy of goals according to aspects of the invention. For example, the first level of the hierarchy is to not exceed the maximum number of payees each vendor can handle in each country (e.g., from FIG. 4). The second level of the hierarchy is minimizing the overall price paid by the primary service provider to all of the vendors. The third level of the hierarchy is assigning all payees for a given client within a given country to only one vendor. The fourth level of the hierarchy is assigning payees in each country to at least two vendors. The fifth level of the hierarchy is to not fall below the minimum number of payees for each vendor in each country (e.g., from FIG. 4). All other data depicted in FIGS. 3-7 that is not shown in the hierarchy is held constant (e.g., constant data). In this manner, the hierarchy data and the constant data define the problem for the optimizer to solve.

In embodiments of the invention, the optimizer is first run using the constant data and the first level of the hierarchy. If a solution is achievable, the optimizer is then run using the constant data and the first and second levels of the hierarchy. If at any level of the hierarchy the optimizer cannot provide a solution, the optimizer alerts the user, the user relaxes (e.g., changes the value of) at least one of the constraints and/or values of the hierarchy, and the optimizer is re-run. This iterative process is repeated until a solution is found that satisfies all of the constant data and all levels of the hierarchy.

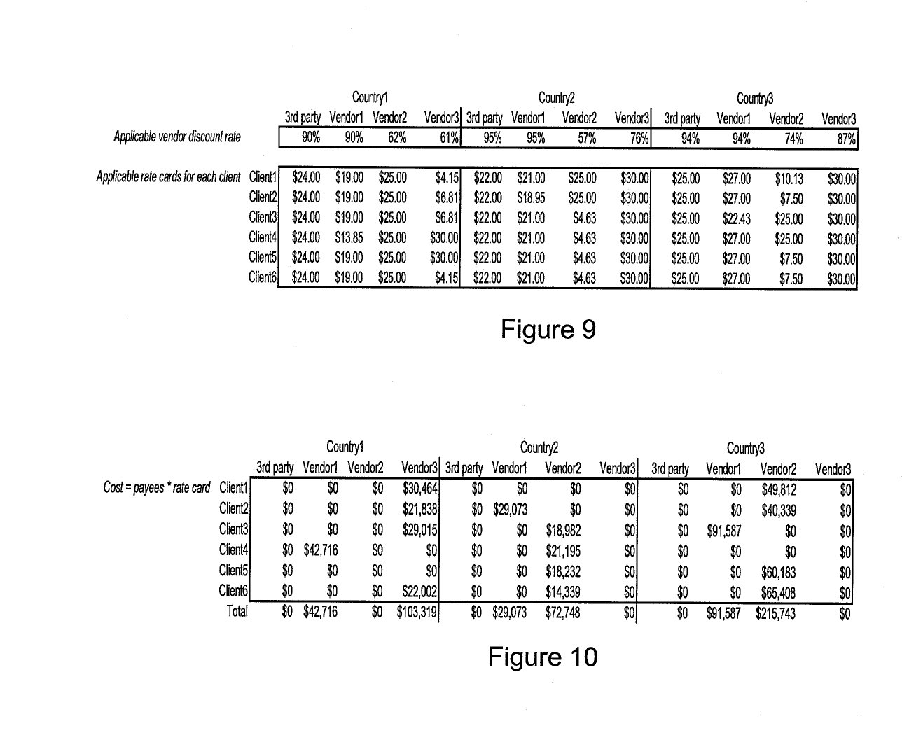

FIGS. 9 and 10 show data that is calculated by the optimizer during intermediate steps of the iterative process. For example, FIG. 9 shows exemplary applicable vendor rates, which are a function of the vendor rate card data (FIG. 4), the vendor discount data (FIG. 5), and the number of payees assigned to each vendor in each country (as determined by the optimizer). In embodiments, an applicable rate is the price from each rate card for the given volume of payees by country for a particular client and the vendor discount for the given volume of payees across all clients in each country. Also, FIG. 10 shows vendor prices based upon the rates of FIG. 9 and the number of payees assigned by the optimizer to each vendor in each country. In embodiments, the optimizer utilizes numerical methods to minimize the total costs shown in FIG. 10.

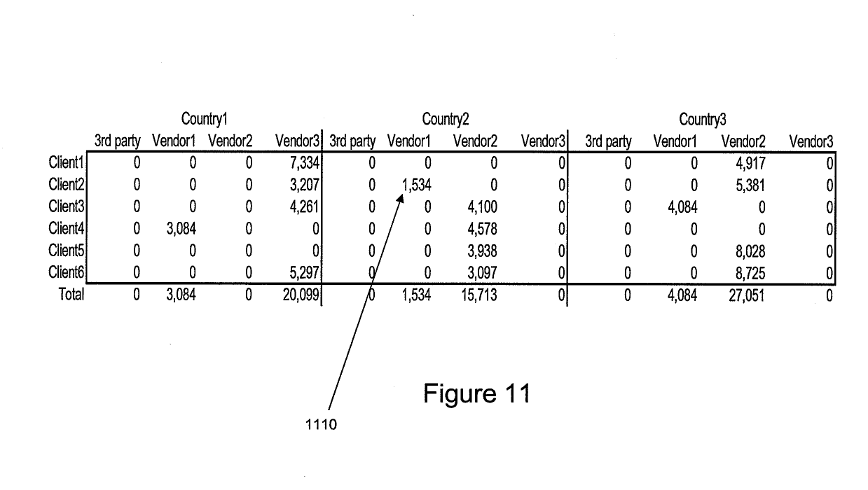

FIG. 11 shows a solution of the exemplary problem depicted in FIGS. 3-8. For example, once the total cost (e.g., FIG. 10) is minimized, the allocations of payees to vendors that resulted in the minimized cost are depicted as shown. Inspection of FIG. 11 reveals that the levels one through four of the hierarchy are achieved without relaxing the values of these levels. However, the constraint related to the fifth level of the hierarchy was relaxed. This is illustrated by the value of 1534 payees handled by Vendor1 for Client2 in Country2 (indicated by reference character 1110). The initial value of this constraint, from FIG. 4, was 3000. However, this value was relaxed in order to achieve an optimal solution that satisfies the remainder of the data. In this manner, even though the problem is initially over-constrained, implementations of the invention provide a methodology for arriving at a feasible solution.

### PROCESSES OF THE INVENTION

The steps of the flow diagram described herein may be implemented in the environment of FIGS. 1 and/or 2. The flow diagram may equally represent a high-level block diagram of the invention. The steps of the flow diagram may be implemented and executed from a server, in a client-server relationship, by computing devices in an ad hoc network, or they may run on a user workstation with operative information conveyed to the user workstation. Additionally, the invention can take the form of an entirely hardware embodiment, an entirely software embodiment or an embodiment containing both hardware and software elements. In an embodiment, the software elements include firmware, resident software, microcode, etc.

Furthermore, the invention can take the form of a computer program product accessible from a computer-usable or computer-readable medium providing program code for use by or in connection with a computer or any instruction execution system. The software and/or computer program product can be implemented in the environments of FIGS. 1 and/or 2. For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

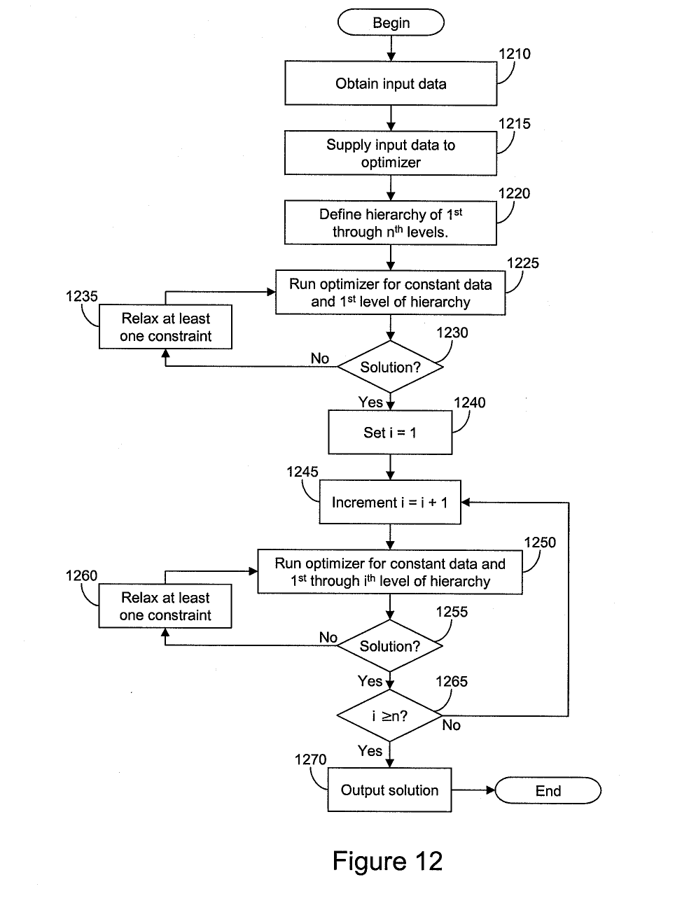

FIG. 12 shows a flow diagram depicting steps of a method for determining an optimum solution for managed business processes according to aspects of the invention. At step 1210, input data is obtained. In embodiments, this comprises obtaining baseline data, constraints, and goals, such as that described above with respect to FIGS. 2-7. In implementations, the input data (e.g., baseline data, constraints, and goals) may be obtained and defined in any suitable manner. For example, aspects of input data may be obtained (e.g., from vendors) using a request for proposal (RFP) and/or an auction amongst vendors. More specifically, in response to an RFP or auction, vendors provide data (e.g., capacities, rates, etc.) to the primary service provider. Additional constraints and/or goals may be defined by the user, for example, according to the primary service provider's business strategy.

At step 1215, the input data is provided to an optimizer. In embodiments, the input data is provided to an optimizer, such as that described above with respect to FIG. 2, by any suitable combination of manual and/or automatic data entry. For example, a user may use a GUI to assign values to data fields.

At step 1220, the user defines a hierarchy of goals. For example, the hierarchy can be defined using a GUI of the optimizer. In embodiments, the hierarchy has one through “n” levels of goals, with the 1^{st} level being the highest importance and the n^{th} level being the lowest importance. Any input data that is not organized in the hierarchy is automatically defined by the optimizer as constant data.

At step 1225, the user causes the optimizer to run (e.g., execute) using the constant data and the 1^{st} level goal. For example, the optimizer utilizes numerical optimization techniques to define an optimization problem based upon the input data and determine a solution (if possible) that satisfies the constant data and the 1^{st} level goal. At step 1230, the optimizer determines whether a solution is possible based upon the constant data and the 1^{st} level goal. If a solution is not possible (e.g., the problem is over-constrained), then at step 1235 the user relaxes (e.g., changes the value) of at least one constraints. Additionally or alternatively, the user could change (e.g., re-define) the hierarchy of goals. Then the process returns to step 1225, where the optimizer is re-run with the updated data.

If a solution is determined possible at step 1230, then at step 1240 a counter “i” is set to the value of one. Then at step 1245, the counter is incremented. At step 1250, the optimizer is run for the constant data and the 1^{st} through i^{th} level goals of the hierarchy. At step 1255, the optimizer determines whether a solution is possible using the constant data and the 1^{st} through i^{th} level goals of the hierarchy. If a solution is not possible (e.g., the problem is over-constrained), then at step 1260 the user relaxes (e.g., changes the value) of one or more constraints that are preventing a feasible solution at the i^{th} level goal. Additionally or alternatively, the user could change (e.g., re-define) the hierarchy of goals. Then the process returns to step 1250, where the optimizer is re-run with the updated data.

If, at step 1255, a solution is possible, then at step 1265 the counter “i” is compared to the number of levels “n” of the hierarchy. If the counter is less than the number of levels in the hierarchy, then the process loops back to step 1245, where the counter is incremented. However, if at step 1265 the counter equals or exceeds the number of levels of the hierarchy, then at step 1270 the solution is output. In embodiments, the solution may be output in any suitable manner, such as, for example, displaying results on a screen, storing results to a file, creating a hard copy (e.g., printing), transmitting the solution to a service provider, etc. By relaxing at least one constraint/goal, implementations of the invention provide an allocation solution where before one could not be determined.

Implementations of the invention also allow a primary service provider to analyze real-time changes in data. For example, the values of the input data, including the hierarchy data and the constant data, may be changed at will by the user to reflect changing conditions (or even anticipated changes in conditions). For example, the definition of the hierarchy may change over time as client requirements change, as vendor capabilities and/or capacities change, or as the primary service provider's strategy changes. As a further example, as new vendors with different prices are added to the input data and/or when old vendors are dropped from the input data, rerunning the optimizer may provide an updated solution.

Moreover, the invention is not limited to the input data described in the examples above; instead any suitable input data can be used with implementations of the invention. For example, a third party may be defined in the optimizer as a payroll vendor engaged by a client before the primary service provider is engaged. The client may have a contract with the third party that extends into the future, such that some payees are constrained to that third party until expiration of the contract. Such a constraint can be included in the input data. When the contract expires, the third party can be re-defined as one of the many vendors, and the payees re-defined in the general pool of payees.

Additionally, implementations of the invention can be used for planning (e.g., speculative) purposes. For example, implementations of the invention can be used to perform a “what-if” analysis of potential clients as though they were actual clients with the primary service provider. It might be, for instance, that the optimal assignment of clients to vendors would be altered by anticipating forthcoming deals rather than limiting the analysis to signed deals. Additionally or alternatively, it may also be helpful periodically to relax the constraint that payees must remain with their currently assigned vendor in order to explore whether rebalancing the portfolio would lead to a significant reduction in price. Such rebalancing is helpful as vendors exit the business or their contracts with the primary service provider expire.

While the invention has been described in terms of embodiments, those skilled in the art will recognize that the invention can be practiced with modifications and in the spirit and scope of the appended claims.

What is claimed:

1. A method for allocating outsourced business processes among a plurality of performing entities, comprising:
defining a hierarchy of goals from a subset of data input to an optimization tool embodied in a computer infrastructure, wherein the data includes constraints;
iteratively running the optimization tool based on the data and the hierarchy;
relaxing at least one of the constraints to generate a solution that satisfies the data and the hierarchy; and
outputting the solution.

2. The method of claim 1, further comprising receiving an alert from the optimization tool that a solution for a current iteration does not exist.

3. The method of claim 2, wherein the relaxing is performed in response to the receiving the alert.

4. The method of claim 1, wherein the data comprises at least one of:
number of payees per client in a geographic area;
vendor rate card data;
vendor discount rate data; and
vendor capacity data.

5. The method of claim 1, wherein the relaxing is performed by a human operator.

6. The method of claim 1, wherein the relaxing comprises changing a value of the at least one of the constraints.

7. The method of claim 6, wherein the relaxing is accomplished using a graphical user interface.

8. The method of claim 1, wherein the outsourced business processes comprise payroll services for plural payees, the performing entities comprise vendors, and the solution comprises an allocation of the payees to the vendors.

9. The method of claim 1, wherein the outputting the solution comprises at least one of: visually displaying the solution, creating a hard copy of the solution, storing the solution in data storage, and transmitting the solution to a customer.

10. The method of claim 1, wherein at least one of the defining, the iteratively running, the relaxing, and the outputting is provided by a service provider under a subscription and/or fee agreement and/or based on advertising content to one or more third parties.

11. The method of claim 1, wherein a service provider at least one of creates, maintains, deploys and supports the computer infrastructure.

12. A method for determining an optimized solution for allocation of managed business processes, comprising:
providing a computer infrastructure that is structured and arranged to:
receive data associated with the managed business processes;
define an optimization problem based upon the data;
execute an optimization routine to solve the optimization problem;
generate an alert when the optimization problem is over-constrained;
receive at least one change of at least one aspect of the data; and
generate a solution to the optimization problem that satisfies the data and the at least one change.

13. The method of claim 12, wherein the data comprises at least one of:
number of payees per client in a geographic area;
vendor rate card data;
vendor discount rate data; and
vendor capacity data.

14. The method of claim 12, wherein the data comprises constant data and hierarchical data.

15. The method of claim 14, wherein the at least one change of at least one aspect of the data is associated with the hierarchical data.

16. The method of claim 12, wherein the solution comprises an allocation of payees to vendors.

17. The method of claim 12, wherein a service provider at least one of creates, maintains, deploys and supports the computer infrastructure.

18. A computer program product comprising a computer usable medium having a computer readable program embodied in the medium, wherein the computer readable program when executed on a computing device is operable to cause the computing device to:
iteratively solve an optimization problem while descending through levels of hierarchical goals associated with a plurality of business processes;
prompt a user to relax at least one constraint of the optimization problem when the optimization problem is over-constrained; and
generate a solution based upon the hierarchical goals and the relaxing.

19. The computer program product of claim 18, wherein the optimization problem is defined by data comprising at least one of: number of payees per client in a geographic area; vendor rate card data; vendor discount rate data; and vendor capacity data.

20. The computer program product of claim 18, wherein the solution comprises an allocation of payees to vendors that minimizes a collective price paid by a primary service provider to the vendors.
